(19) United States
(12) Patent Application Publication
(10) Pub. No.: US 2026/0214241 A1
(43) Pub. Date: Jul. 23, 2026

(54) METHOD AND APPARATUS FOR ENCODING/DECODING IMAGE AND RECORDING MEDIUM FOR STORING BITSTREAM

(71) Applicants: HYUNDAI MOTOR COMPANY, Seoul (KR); KIA CORPORATION, Seoul (KR)

(72) Inventors: Jin Heo, Yongin-si (KR); Jungah Choi, Seoul (KR); Seung Wook Park, Yongin-si (KR)

(73) Assignees: HYUNDAI MOTOR COMPANY, Seoul (KR); KIA CORPORATION, Seoul (KR)

(21) Appl. No.: 19/137,774

(22) PCT Filed: Mar. 13, 2024
(86) PCT No.: PCT/KR2024/003237

§ 371 Date: Jun. 11, 2025

(30) Foreign Application Priority Data
Mar. 13, 2023 (KR) 10-2023-0032525
Mar. 13, 2024 (KR) 10-2024-0035071

(51) Int. Cl. H04N 19/159; H04N 19/105; H04N 19/176; H04N 19/196; H04N 19/593

(52) U.S. Cl. CPC H04N 19/159; H04N 19/105; H04N 19/176; H04N 19/196; H04N 19/593

(57) ABSTRACT

The present disclosure provides a method for decoding an image, and the method comprises partitioning a current block into a first partition and a second partition according to a split boundary, determining whether an intra block copy mode is applied to the first partition, determining a block vector of the first partition representing a reference block within a block vector search range of the current block when the intra block copy mode is applied to the first partition, determining a reference block referred to by the first partition based on the block vector, and predicting the first partition based on the reference block.

### TECHNICAL FIELD

The present disclosure relates to an image encoding/decoding method and apparatus and a recording medium for storing a bitstream. More particularly, the present disclosure relates to an image encoding/decoding method and apparatus using an intra prediction method and a recording medium for storing a bitstream.

### BACKGROUND ART

Recently, the demand for high-resolution, high-quality images such as ultra-high definition (UHD) images is increasing in various application fields. As image data becomes higher in resolution and quality, the amount of data increases relatively compared to existing image data. Therefore, when transmitting image data using media such as existing wired and wireless broadband lines or storing image data using existing storage media, the transmission and storage costs increase. In order to solve these problems that occur as image data becomes higher in resolution and quality, high-efficiency image encoding/decoding technology for images with higher resolution and quality is required.

In geometric partitioning mode, there has been discussion about a method for applying different prediction modes to a resulting partition. Specifically, there has been discussion about various methods for improving prediction accuracy of a block by increasing the number of types of prediction modes applicable to a partition.

### DISCLOSURE

### Technical Problem

An object of the present disclosure is to provide a method and apparatus for encoding/decoding an image with improved encoding/decoding efficiency.

Another object of the present disclosure is to provide a recording medium for storing a bitstream that is generated by generated by a method or apparatus for decoding an image, which is provided in the present disclosure.

### Technical Solution

A method for decoding an image according to an embodiment of the present disclosure may comprise partitioning a current block into a first partition and a second partition according to a split boundary, determining whether an intra template matching mode is applied to the first partition, determining a template of the first partition when the intra template matching mode is applied to the first partition, determining a reference template corresponding to the template of the first partition within a template search range of the current block, determining a reference block referred to by the first partition based on the reference template, and predicting the first partition based on the reference block.

According to an embodiment, the first partition may include an upper-left sample of the current block, and the template of the first partition may include at least one of a left region positioned to the left side of the first partition, an upper region positioned above the first partition, and an upper-left region positioned at the upper-left of the first partition.

According to an embodiment, when the current block is adjacent to an upper boundary of a slice or picture including the current block, the template may not include the upper region and the upper-left region but include the left region, and when the current block is adjacent to a left boundary of the slice or picture including the current block, the template may not include the left region and the upper-left region but include the upper region.

According to an embodiment, a width of the upper region may be identical to an upper-side width of the first partition, and a height of the left region may be identical to a left height of the first partition.

According to an embodiment, the width of the upper region may be identical to a width of the current block, and the height of the left region may be identical to a height of the current block.

According to an embodiment, the template of the first partition may further include at least one of a lower-left region adjacent to a lower side of the left region and an upper-right region adjacent to a right side of the upper region.

According to an embodiment, the lower-left region and the upper-right region may be determined according to an extended split boundary of the current block.

According to an embodiment, the lower-left region may be determined to be adjacent in a lower-left direction from a lower-left vertex of the current block, and the upper-right region may be determined to be adjacent in an upper-right direction from an upper-right vertex of the current block.

According to an embodiment, the first partition may include the upper-left sample of the current block.

According to an embodiment, the first partition may not include the upper-left sample of the current block but be adjacent to at least one of a left boundary and an upper boundary of the current block, and when the first partition is adjacent to the left boundary of the current block, the template of the first partition may include the left region positioned to the left side of the first partition, and when the first partition is adjacent to the upper boundary of the current block, the template of the first partition may include the upper region positioned above the first partition.

According to an embodiment, the second partition may apply one of an inter prediction mode, an intra prediction mode, an intra block copy mode, and an intra template matching mode.

According to an embodiment, irrespective of whether the intra template matching mode is applied to the first partition, a prediction method applied to the second partition may be determined.

According to an embodiment, when the intra template matching mode is applied to the first partition and the intra prediction mode is applied to the second partition, the second partition may be predicted by one of predetermined intra prediction methods, and when the intra template matching mode is not applied to the first partition and the intra prediction mode is applied to the second partition, the second partition may be predicted by one of prediction methods not included in the predetermined intra prediction methods, and the predetermined intra prediction methods may include at least one of planar mode, DC mode, horizontal mode, or vertical mode. When the intra template matching mode is applied to the first partition and the intra prediction mode is applied to the second partition, the second partition may be predicted by existing intra prediction modes.

According to an embodiment, when the intra template matching mode is applied to both the first partition and the second partition, the template of the first partition and a template of the second partition may be configured not to be identical to each other.

A method for encoding an image according to an embodiment of the present disclosure may comprise partitioning a current block into a first partition and a second partition according to a split boundary, determining whether an intra template matching mode is applied to the first partition, determining a template of the first partition when the intra template matching mode is applied to the first partition, determining a reference template corresponding to the template of the first partition within a template search range of the current block, determining a reference block referred to by the first partition based on the reference template, and predicting the first partition based on the reference block.

A non-transitory computer-readable recording medium according to an embodiment of the present disclosure may store a bitstream generated by the method for encoding an image.

A transmission method according to an embodiment of the present disclosure may transmit a bitstream generated by the method for encoding an image.

A method for decoding an image according to an embodiment of the present disclosure may comprise partitioning a current block into a first partition and a second partition according to a split boundary, determining whether an intra block copy mode is applied to the first partition, determining a block vector of the first partition representing a reference block within a block vector search range of the current block when the intra block copy mode is applied to the first partition, determining a reference block referred to by the first partition based on the block vector, and predicting the first partition based on the reference block.

According to an embodiment, whether the intra block copy mode is applied to the first partition may be determined based on a first partitioning area flag, and when the intra block copy mode is not applied to the first partition, the intra block copy mode may be applied to the second partition, and when the intra block copy mode is applied to the first partition, whether the intra block copy mode is applied to the second partition may be determined based on a second partitioning area flag.

According to an embodiment, whether the intra block copy mode is applied to the first partition may be determined based on the first partitioning area flag, and whether the intra block copy mode is applied to the second partition may be determined based on the second partitioning area flag.

According to an embodiment, the second partition may apply one of an inter prediction mode, an intra prediction mode, an intra block copy mode, and an intra template matching mode.

According to an embodiment, irrespective of whether the intra block copy mode is applied to the first partition, a prediction method applied to the second partition may be determined.

According to an embodiment, when the intra block copy mode is applied to the first partition and the intra prediction mode is applied to the second partition, the second partition may be predicted by one of predetermined intra prediction methods, and when the intra block copy mode is not applied to the first partition and the intra prediction mode is applied to the second partition, the second partition may be predicted by one of prediction methods not included in the predetermined intra prediction methods, and the predetermined intra prediction methods may include at least one of planar mode, DC mode, horizontal mode, or vertical mode. When the intra block copy mode is applied to the first partition and the intra prediction mode is applied to the second partition, the second partition may be predicted by existing intra prediction modes.

According to an embodiment, when the intra block copy mode is applied to both the first partition and the second partition, the block vector of the first partition and a block vector of the second partition may be configured not to be identical to each other.

According to an embodiment, when the intra block copy mode is applied to the first partition and the inter prediction mode is applied to the second partition, the block vector of the first partition may be derived based on a motion vector of the second partition.

According to an embodiment, the method for decoding an image may further comprise acquiring a difference vector representing a difference between the block vector of the first partition and the motion vector of the second partition, and the block vector of the first partition may be derived based on the motion vector of the second partition and the difference vector.

A method for encoding an image according to an embodiment of the present disclosure may comprise partitioning a current block into a first partition and a second partition according to a split boundary, determining whether an intra block copy mode is applied to the first partition, determining a block vector of the first partition representing a reference block within a block vector search range of the current block when the intra block copy mode is applied to the first partition, determining a reference block referred to by the first partition based on the block vector, and predicting the first partition based on the reference block.

A non-transitory computer-readable recording medium according to an embodiment of the present disclosure may store a bitstream generated by the method for encoding an image.

A transmission method according to an embodiment of the present disclosure may transmit a bitstream generated by the method for encoding an image.

The features briefly summarized above with respect to the present disclosure are provided as an example only to explain the detailed description and are not construed to limit the scope of the present disclosure.

### Advantageous Effects

The present disclosure proposes various embodiments of a method for applying an intra template matching mode to a partition in geometric partitioning mode.

In addition, the present disclosure proposes various embodiments of a method for applying an intra block copy mode to a partition in geometric partitioning mode.

In addition, the present disclosure proposes various embodiments of a method for efficiently encoding a block vector for applying an intra block copy mode in geometric partitioning mode.

According to the various embodiments, as prediction accuracy of geometric partitioning mode is improved, overall coding efficiency can be improved.

### DESCRIPTION OF DRAWINGS

FIG. 1 is a block diagram showing a configuration of an encoding apparatus according to an embodiment of the present disclosure.

FIG. 2 is a block diagram showing a configuration of a decoding apparatus according to an embodiment of the present disclosure.

FIG. 3 is a diagram schematically showing a video coding system to which the present disclosure is applicable.

FIG. 4 shows combination of intra prediction and inter prediction that may occur in geometric partitioning mode.

FIG. 5 shows a method for generating a prediction block according to an intra template matching mode of a partition in geometric partitioning mode.

FIG. 6 shows an embodiment of a template including left, upper, and upper-left reference samples for intra template matching of a partition including an upper-left sample of a block.

FIG. 7 shows an embodiment of a template including not only left, upper and upper-left reference samples but also reference samples of a region determined according an extended split boundary.

FIG. 8 shows an embodiment of a template including not only left, upper and upper-left reference samples but also lower-left and upper-right reference samples.

FIG. 9 shows a method for predicting a second partition of a current block according to intra template matching mode.

FIG. 10 shows an embodiment of a template including left and upper reference samples for intra template matching of a partition not including an upper-left sample of a block.

FIG. 11 describes a method for predicting a partition according to intra block copy mode in geometric partitioning mode.

FIG. 12 shows a method for predicting a second partition of a current block according to intra block copy mode.

FIG. 13 shows a method for generating a prediction block based on intra block copy for a region in which intra prediction is performed in geometric partitioning mode.

FIG. 14 shows a method for reducing a size of information of a block vector by using a unidirectional motion vector.

FIG. 15 shows an embodiment of a prediction method according to geometric partitioning mode in which intra template matching mode is applied.

FIG. 16 shows an embodiment of a prediction method according to geometric partitioning mode in which intra block copy mode is applied.

FIG. 17 exemplary illustrates a content streaming system to which an embodiment according to the present disclosure is applicable.

### BEST MODE

A method for decoding an image according to an embodiment of the present disclosure may comprise partitioning a current block into a first partition and a second partition according to a partition boundary, determining whether an intra template matching mode is applied to the first partition, determining a template of the first partition when the intra template matching mode is applied to the first partition, determining a reference template corresponding to the template of the first partition within a template search range of the current block, determining a reference block referred to by the first partition based on the reference template, and predicting the first partition based on the reference block.

### MODE FOR INVENTION

The present disclosure may have various modifications and embodiments, and specific embodiments are illustrated in the drawings and described in detail in the detailed description. However, this is not intended to limit the present disclosure to specific embodiments, but should be understood to include all modifications, equivalents, or substitutes included in the spirit and technical scope of the present disclosure. Similar reference numerals in the drawings indicate the same or similar functions throughout various aspects. The shapes and sizes of elements in the drawings may be provided by way of example for a clearer description. The detailed description of the exemplary embodiments described below refers to the accompanying drawings, which illustrate specific embodiments by way of example. These embodiments are described in sufficient detail to enable those skilled in the art to practice the embodiments. It should be understood that the various embodiments are different from each other, but are not necessarily mutually exclusive. For example, specific shapes, structures, and characteristics described herein may be implemented in other embodiments without departing from the spirit and scope of the present disclosure with respect to one embodiment. It should also be understood that the positions or arrangements of individual components within each disclosed embodiment may be changed without departing from the spirit and scope of the embodiment. Accordingly, the detailed description set forth below is not intended to be limiting, and the scope of the exemplary embodiments is defined only by the appended claims, along with the full scope of equivalents to which such claims are entitled, if properly described.

In the present disclosure, the terms first, second, etc. may be used to describe various components, but the components should not be limited by the terms. The terms are only used for the purpose of distinguishing one component from another. For example, without departing from the scope of the present disclosure, the first component may be referred to as the second component, and similarly, the second component may also be referred to as the first component. The term is and/or includes a combination of a plurality of related described items or any item among a plurality of related described items.

The components shown in the embodiments of the present disclosure are independently depicted to indicate different characteristic functions, and do not mean that each component is formed as a separate hardware or software configuration unit. That is, each component is listed and included as a separate component for convenience of explanation, and at least two of the components may be combined to form a single component, or one component may be divided into multiple components to perform a function, and embodiments in which components are integrated and embodiments in which each component is divided are also included in the scope of the present disclosure as long as they do not deviate from the essence of the present disclosure.

The terminology used in the present disclosure is only used to describe specific embodiments and is not intended to limit the present disclosure. The singular expression includes the plural expression unless the context clearly indicates otherwise. In addition, some components of the present disclosure are not essential components that perform essential functions in the present disclosure and may be optional components only for improving performance. The present disclosure may be implemented by including only essential components for implementing the essence of the present disclosure excluding components only used for improving performance, and a structure including only essential components excluding optional components only used for improving performance is also included in the scope of the present disclosure.

In an embodiment, the term “at least one” may mean one of a number greater than or equal to 1, such as 1, 2, 3, and 4. In an embodiment, the term “a plurality of” may mean one of a number greater than or equal to 2, such as 2, 3, and 4.

Hereinafter, embodiments of the present disclosure will be specifically described with reference to the drawings. In describing the embodiments of this specification, if it is determined that a detailed description of a related known configuration or function may obscure the subject matter of this specification, the detailed description will be omitted, and the same reference numerals will be used for the same components in the drawings, and repeated descriptions of the same components will be omitted.

### Description of Terms

Hereinafter, “image” may mean one picture constituting a video, and may also refer to the video itself. For example, “encoding and/or decoding of an image” may mean “encoding and/or decoding of a video,” and may also mean “encoding and/or decoding of one of images constituting the video.”

Hereinafter, “moving image” and “video” may be used with the same meaning and may be used interchangeably. In addition, a target image may be an encoding target image that is a target of encoding and/or a decoding target image that is a target of decoding. In addition, the target image may be an input image input to an encoding apparatus and may be an input image input to a decoding apparatus. Here, the target image may have the same meaning as a current image.

Hereinafter, “image”, “picture”, “frame” and “screen” may be used with the same meaning and may be used interchangeably.

Hereinafter, a “target block” may be an encoding target block that is a target of encoding and/or a decoding target block that is a target of decoding. In addition, the target block may be a current block that is a target of current encoding and/or decoding. For example, “target block” and “current block” may be used with the same meaning and may be used interchangeably.

Hereinafter, “block” and “unit” may be used with the same meaning and may be used interchangeably. In addition, “unit” may mean including a luma component block and a chroma component block corresponding thereto in order to distinguish it from a block. For example, a coding tree unit (CTU) may be composed of one luma component (Y) coding tree block (CTB) and two chroma component (Cb, Cr) coding tree blocks related to it.

Hereinafter, “sample”, “picture element” and “pixel” may be used with the same meaning and may be used interchangeably. Herein, a sample may represent a basic unit that constitutes a block.

Hereinafter, “inter” and “inter-screen” may be used with the same meaning and can be used interchangeably.

Hereinafter, “intra” and “in-screen” may be used with the same meaning and can be used interchangeably.

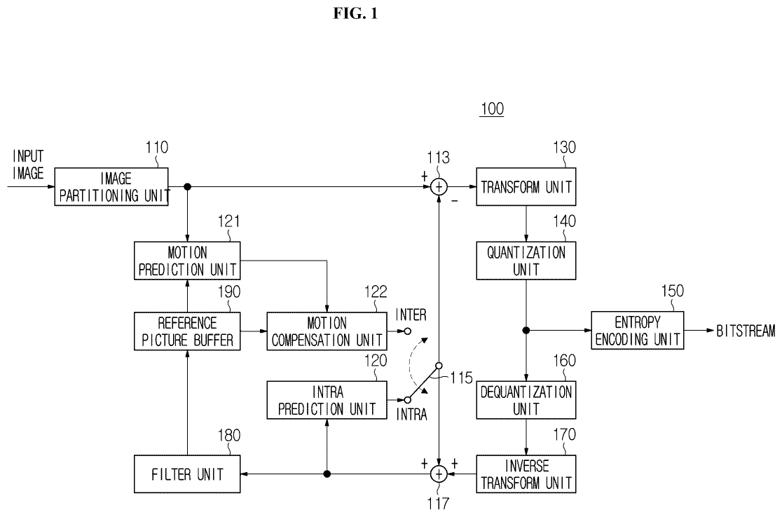

FIG. 1 is a block diagram showing a configuration of an encoding apparatus according to an embodiment of the present disclosure.

The encoding apparatus 100 may be an encoder, a video encoding apparatus, or an image encoding apparatus. A video may include one or more images. The encoding apparatus 100 may sequentially encode one or more images.

Referring to FIG. 1, the encoding apparatus 100 may include an image partitioning unit 110, an intra prediction unit 120, a motion prediction unit 121, a motion compensation unit 122, a switch 115, a subtractor 113, a transform unit 130, a quantization unit 140, an entropy encoding unit 150, a dequantization unit 160, an inverse transform unit 170, an adder 117, a filter unit 180 and a reference picture buffer 190.

In addition, the encoding apparatus 100 may generate a bitstream including information encoded through encoding of an input image, and output the generated bitstream. The generated bitstream may be stored in a computer-readable recording medium, or may be streamed through a wired/wireless transmission medium.

The image partitioning unit 110 may partition the input image into various forms to increase the efficiency of video encoding/decoding. That is, the input video is composed of multiple pictures, and one picture may be hierarchically partitioned and processed for compression efficiency, parallel processing, etc. For example, one picture may be partitioned into one or multiple tiles or slices, and then partitioned again into multiple CTUs (Coding Tree Units). Alternatively, one picture may first be partitioned into multiple sub-pictures defined as groups of rectangular slices, and each sub-picture may be partitioned into the tiles/slices. Here, the sub-picture may be utilized to support the function of partially independently encoding/decoding and transmitting the picture. Since multiple sub-pictures may be individually reconstructed, it has the advantage of easy editing in applications that configure multi-channel inputs into one picture. In addition, a tile may be divided horizontally to generate bricks. Here, the brick may be utilized as the basic unit of parallel processing within the picture. In addition, one CTU may be recursively partitioned into quad trees (QTs), and the terminal node of the partition may be defined as a CU (Coding Unit). The CU may be partitioned into a PU (Prediction Unit), which is a prediction unit, and a TU (Transform Unit), which is a transform unit, to perform prediction and partition. Meanwhile, the CU may be utilized as the prediction unit and/or the transform unit itself. Here, for flexible partition, each CTU may be recursively partitioned into multi-type trees (MTTs) as well as quad trees (QTs). The partition of the CTU into multi-type trees may start from the terminal node of the QT, and the MTT may be composed of a binary tree (BT) and a triple tree (TT). For example, the MTT structure may be classified into a vertical binary split mode (SPLIT_BT_VER), a horizontal binary split mode (SPLIT_BT_HOR), a vertical ternary split mode (SPLIT_TT_VER), and a horizontal ternary split mode (SPLIT_TT_HOR). In addition, a minimum block size (MinQTSize) of the quad tree of the luma block during partition may be set to 16×16, a maximum block size (MaxBtSize) of the binary tree may be set to 128×128, and a maximum block size (MaxTtSize) of the triple tree may be set to 64×64. In addition, a minimum block size (MinBtSize) of the binary tree and a minimum block size (MinTtSize) of the triple tree may be specified as 4×4, and the maximum depth (MaxMttDepth) of the multi-type tree may be specified as 4. In addition, in order to increase the encoding efficiency of the I slice, a dual tree that differently uses CTU partition structures of luma and chroma components may be applied. On the other hand, in P and B slices, the luma and chroma CTBs (Coding Tree Blocks) within the CTU may be partitioned into a single tree that shares the coding tree structure.

The encoding apparatus 100 may perform encoding on the input image in the intra mode and/or the inter mode. Alternatively, the encoding apparatus 100 may perform encoding on the input image in a third mode (e.g., IBC mode, Palette mode, etc.) other than the intra mode and the inter mode. However, if the third mode has functional characteristics similar to the intra mode or the inter mode, it may be classified as the intra mode or the inter mode for convenience of explanation. In the present disclosure, the third mode will be classified and described separately only when a specific description thereof is required.

When the intra mode is used as the prediction mode, the switch 115 may be switched to intra, and when the inter mode is used as the prediction mode, the switch 115 may be switched to inter. Here, the intra mode may mean an intra prediction mode, and the inter mode may mean an inter prediction mode. The encoding apparatus 100 may generate a prediction block for an input block of the input image. In addition, the encoding apparatus 100 may encode a residual block using a residual of the input block and the prediction block after the prediction block is generated. The input image may be referred to as a current image which is a current encoding target. The input block may be referred to as a current block which is a current encoding target or an encoding target block.

When a prediction mode is an intra mode, the intra prediction unit 120 may use a sample of a block that has been already encoded/decoded around a current block as a reference sample. The intra prediction unit 120 may perform spatial prediction for the current block by using the reference sample, or generate prediction samples of an input block through spatial prediction. Herein, the intra prediction may mean in-screen prediction.

As an intra prediction method, non-directional prediction modes such as DC mode and Planar mode and directional prediction modes (e.g., 65 directions) may be applied. Here, the intra prediction method may be expressed as an intra prediction mode or an in-screen prediction mode.

When a prediction mode is an inter mode, the motion prediction unit 121 may retrieve a region that best matches with an input block from a reference image in a motion prediction process, and derive a motion vector by using the retrieved region. In this case, a search region may be used as the region. The reference image may be stored in the reference picture buffer 190. Here, when encoding/decoding for the reference image is performed, it may be stored in the reference picture buffer 190.

The motion compensation unit 122 may generate a prediction block of the current block by performing motion compensation using a motion vector. Herein, inter prediction may mean inter-screen prediction or motion compensation.

When the value of the motion vector is not an integer, the motion prediction unit 121 and the motion compensation unit 122 may generate the prediction block by applying an interpolation filter to a partial region of the reference picture. In order to perform inter prediction or motion compensation, it may be determined whether the motion prediction and motion compensation mode of the prediction unit included in the coding unit is one of a skip mode, a merge mode, an advanced motion vector prediction (AMVP) mode, and an intra block copy (IBC) mode based on the coding unit and inter prediction or motion compensation may be performed according to each mode.

In addition, based on the above inter prediction method, an AFFINE mode of sub-PU based prediction, an SbTMVP (Subblock-based Temporal Motion Vector Prediction) mode, an MMVD (Merge with MVD) mode of PU-based prediction, and a GPM (Geometric Partitioning Mode) mode may be applied. In addition, in order to improve the performance of each mode, HMVP (History based MVP), PAMVP (Pairwise Average MVP), CIIP (Combined Intra/Inter Prediction), AMVR (Adaptive Motion Vector Resolution), BDOF (Bi-Directional Optical-Flow), BCW (Bi-predictive with CU Weights), LIC (Local Illumination Compensation), TM (Template Matching), OBMC (Overlapped Block Motion Compensation), etc. may be applied.

The subtractor 113 may generate a residual block by using a difference between an input block and a prediction block. The residual block may be called a residual signal. The residual signal may mean a difference between an original signal and a prediction signal. Alternatively, the residual signal may be a signal generated by transforming or quantizing, or transforming and quantizing a difference between the original signal and the prediction signal. The residual block may be a residual signal of a block unit.

The transform unit 130 may generate a transform coefficient by performing transform on a residual block, and output the generated transform coefficient. Herein, the transform coefficient may be a coefficient value generated by performing transform on the residual block. When a transform skip mode is applied, the transform unit 130 may skip transform of the residual block.

A quantized level may be generated by applying quantization to the transform coefficient or to the residual signal. Hereinafter, the quantized level may also be called a transform coefficient in embodiments.

For example, a 4×4 luma residual block generated through intra prediction is transformed using a base vector based on DST (Discrete Sine Transform), and transform may be performed on the remaining residual block using a base vector based on DCT (Discrete Cosine Transform). In addition, a transform block is partitioned into a quad tree shape for one block using RQT (Residual Quad Tree) technology, and after performing transform and quantization on each transformed block partitioned through RQT, a coded block flag (cbf) may be transmitted to increase encoding efficiency when all coefficients become 0.

As another alternative, the Multiple Transform Selection (MTS) technique, which selectively uses multiple transform bases to perform transform, may be applied. That is, instead of partitioning a CU into TUs through RQT, a function similar to TU partition may be performed through the sub-block Transform (SBT) technique. Specifically, SBT is applied only to inter prediction blocks, and unlike RQT, the current block may be partitioned into ½ or ¼ sizes in the vertical or horizontal direction and then transform may be performed on only one of the blocks. For example, if it is partitioned vertically, transform may be performed on the leftmost or rightmost block, and if it is partitioned horizontally, transform may be performed on the topmost or bottommost block.

In addition, LFNST (Low Frequency Non-Separable Transform), a secondary transform technique that additionally transforms the residual signal transformed into the frequency domain through DCT or DST, may be applied. LFNST additionally performs transform on the low-frequency region of 4×4 or 8×8 in the upper left, so that the residual coefficients may be concentrated in the upper left.

The quantization unit 140 may generate a quantized level by quantizing the transform coefficient or the residual signal according to a quantization parameter (QP), and output the generated quantized level. Herein, the quantization unit 140 may quantize the transform coefficient by using a quantization matrix.

For example, a quantizer using QP values of 0 to 51 may be used. Alternatively, if the image size is larger and high encoding efficiency is required, the QP of 0 to 63 may be used. Also, a DQ (Dependent Quantization) method using two quantizers instead of one quantizer may be applied. DQ performs quantization using two quantizers (e.g., Q0 and Q1), but even without signaling information about the use of a specific quantizer, the quantizer to be used for the next transform coefficient may be selected based on the current state through a state transition model.

The entropy encoding unit 150 may generate a bitstream by performing entropy encoding according to a probability distribution on values calculated by the quantization unit 140 or on coding parameter values calculated when performing encoding, and output the bitstream. The entropy encoding unit 150 may perform entropy encoding of information on a sample of an image and information for decoding an image. For example, the information for decoding the image may include a syntax element.

When entropy encoding is applied, symbols are represented so that a smaller number of bits are assigned to a symbol having a high occurrence probability and a larger number of bits are assigned to a symbol having a low occurrence probability, and thus, the size of bit stream for symbols to be encoded may be decreased. The entropy encoding unit 150 may use an encoding method, such as exponential Golomb, context-adaptive variable length coding (CAVLC), context-adaptive binary arithmetic coding (CABAC), etc., for entropy encoding. For example, the entropy encoding unit 150 may perform entropy encoding by using a variable length coding/code (VLC) table. In addition, the entropy encoding unit 150 may derive a binarization method of a target symbol and a probability model of a target symbol/bin, and perform arithmetic coding by using the derived binarization method, and a context model.

In relation to this, when applying CABAC, in order to reduce the size of the probability table stored in the decoding apparatus, a table probability update method may be changed to a table update method using a simple equation and applied. In addition, two different probability models may be used to obtain more accurate symbol probability values.

In order to encode a transform coefficient level (quantized level), the entropy encoding unit 150 may change a two-dimensional block form coefficient into a one-dimensional vector form through a transform coefficient scanning method.

A coding parameter may include information (flag, index, etc.) encoded in the encoding apparatus 100 and signaled to the decoding apparatus 200, such as syntax element, and information derived in the encoding or decoding process, and may mean information required when encoding or decoding an image.

Herein, signaling the flag or index may mean that a corresponding flag or index is entropy encoded and included in a bitstream in an encoder, and may mean that the corresponding flag or index is entropy decoded from a bitstream in a decoder.

The encoded current image may be used as a reference image for another image to be processed later. Therefore, the encoding apparatus 100 may reconstruct or decode the encoded current image again and store the reconstructed or decoded image as a reference image in the reference picture buffer 190.

A quantized level may be dequantized in the dequantization unit 160, or may be inversely transformed in the inverse transform unit 170. A dequantized and/or inversely transformed coefficient may be added with a prediction block through the adder 117. Herein, the dequantized and/or inversely transformed coefficient may mean a coefficient on which at least one of dequantization and inverse transform is performed, and may mean a reconstructed residual block. The dequantization unit 160 and the inverse transform unit 170 may be performed as an inverse process of the quantization unit 140 and the transform unit 130.

The reconstructed block may pass through the filter unit 180. The filter unit 180 may apply a deblocking filter, a sample adaptive offset (SAO), an adaptive loop filter (ALF), a bilateral filter (BIF), luma mapping with chroma scaling (LMCS), etc. to a reconstructed sample, a reconstructed block or a reconstructed image using all or some filtering techniques. The filter unit 180 may be called an in-loop filter. In this case, the in-loop filter is also used as name excluding LMCS.

The deblocking filter may remove block distortion generated in boundaries between blocks. In order to determine whether or not to apply a deblocking filter, whether or not to apply a deblocking filter to a current block may be determined based on samples included in several rows or columns which are included in the block. When a deblocking filter is applied to a block, a different filter may be applied according to a required deblocking filtering strength.

In order to compensate for encoding error using sample adaptive offset, a proper offset value may be added to a sample value. The sample adaptive offset may correct an offset of a deblocked image from an original image by a sample unit. A method of partitioning a sample included in an image into a predetermined number of regions, determining a region to which an offset is applied, and applying the offset to the determined region, or a method of applying an offset in consideration of edge information on each sample may be used.

A bilateral filter (BIF) may also correct the offset from the original image on a sample-by-sample basis for the image on which deblocking has been performed.

The adaptive loop filter may perform filtering based on a comparison result of the reconstructed image and the original image. Samples included in an image may be partitioned into predetermined groups, a filter to be applied to each group may be determined, and differential filtering may be performed for each group. Information of whether or not to apply the ALF may be signaled by coding units (CUs), and a form and coefficient of the adaptive loop filter to be applied to each block may vary.

In LMCS (Luma Mapping with Chroma Scaling), luma mapping (LM) means remapping luma values through a piece-wise linear model, and chroma scaling (CS) means a technique for scaling the residual value of the chroma component according to the average luma value of the prediction signal. In particular, LMCS may be utilized as an HDR correction technique that reflects the characteristics of HDR (High Dynamic Range) images.

The reconstructed block or the reconstructed image having passed through the filter unit 180 may be stored in the reference picture buffer 190. A reconstructed block that has passed through the filter unit 180 may be a part of a reference image. That is, the reference image is a reconstructed image composed of reconstructed blocks that have passed through the filter unit 180. The stored reference image may be used later in inter prediction or motion compensation.

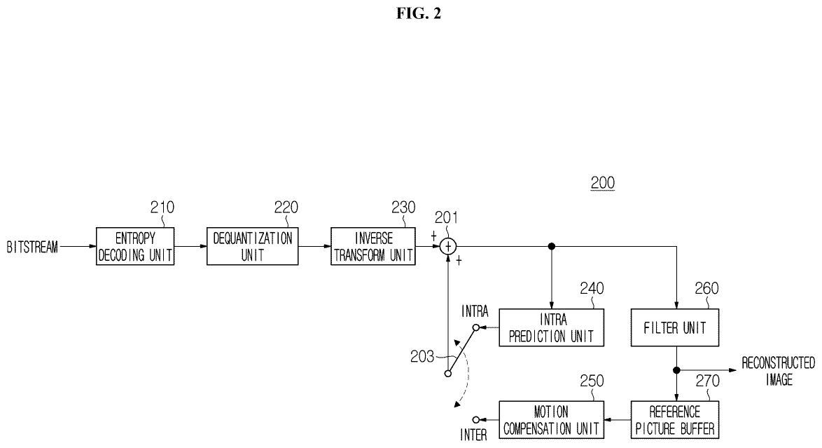

FIG. 2 is a block diagram showing a configuration of a decoding apparatus according to an embodiment of the present disclosure.

A decoding apparatus 200 may a decoder, a video decoding apparatus, or an image decoding apparatus.

Referring to FIG. 2, the decoding apparatus 200 may include an entropy decoding unit 210, a dequantization unit 220, an inverse transform unit 230, an intra prediction unit 240, a motion compensation unit 250, an adder 201, a switch 203, a filter unit 260, and a reference picture buffer 270.

The decoding apparatus 200 may receive a bitstream output from the encoding apparatus 100. The decoding apparatus 200 may receive a bitstream stored in a computer-readable recording medium, or may receive a bitstream that is streamed through a wired/wireless transmission medium. The decoding apparatus 200 may decode the bitstream in an intra mode or an inter mode. In addition, the decoding apparatus 200 may generate a reconstructed image generated through decoding or a decoded image, and output the reconstructed image or decoded image.

When a prediction mode used for decoding is an intra mode, the switch 203 may be switched to intra. Alternatively, when a prediction mode used for decoding is an inter mode, the switch 203 may be switched to inter.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block and the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be an inverse process of the entropy encoding method described above.

The entropy decoding unit 210 may change a one-dimensional vector-shaped coefficient into a two-dimensional block-shaped coefficient through a transform coefficient scanning method to decode a transform coefficient level (quantized level).

A quantized level may be dequantized in the dequantization unit 220, or inversely transformed in the inverse transform unit 230. The quantized level may be a result of dequantization and/or inverse transform, and may be generated as a reconstructed residual block. Herein, the dequantization unit 220 may apply a quantization matrix to the quantized level. The dequantization unit 220 and the inverse transform unit 230 applied to the decoding apparatus may apply the same technology as the dequantization unit 160 and inverse transform unit 170 applied to the aforementioned encoding apparatus.

When an intra mode is used, the intra prediction unit 240 may generate a prediction block by performing, on the current block, spatial prediction that uses a sample value of a block which has been already decoded around a decoding target block. The intra prediction unit 240 applied to the decoding apparatus may apply the same technology as the intra prediction unit 120 applied to the aforementioned encoding apparatus.

When an inter mode is used, the motion compensation unit 250 may generate a prediction block by performing, on the current block, motion compensation that uses a motion vector and a reference image stored in the reference picture buffer 270. The motion compensation unit 250 may generate a prediction block by applying an interpolation filter to a partial region within a reference image when the value of the motion vector is not an integer value. In order to perform motion compensation, it may be determined whether the motion compensation method of the prediction unit included in the corresponding coding unit is a skip mode, a merge mode, an AMVP mode, or a current picture reference mode based on the coding unit, and motion compensation may be performed according to each mode. The motion compensation unit 250 applied to the decoding apparatus may apply the same technology as the motion compensation unit 122 applied to the encoding apparatus described above.

The adder 201 may generate a reconstructed block by adding the reconstructed residual block and the prediction block. The filter unit 260 may apply at least one of inverse-LMCS, a deblocking filter, a sample adaptive offset, and an adaptive loop filter to the reconstructed block or reconstructed image. The filter unit 260 applied to the decoding apparatus may apply the same filtering technology as that applied to the filter unit 180 applied to the aforementioned encoding apparatus.

The filter unit 260 may output the reconstructed image. The reconstructed block or reconstructed image may be stored in the reference picture buffer 270 and used for inter prediction. A reconstructed block that has passed through the filter unit 260 may be a part of a reference image. That is, a reference image may be a reconstructed image composed of reconstructed blocks that have passed through the filter unit 260. The stored reference image may be used later in inter prediction or motion compensation.

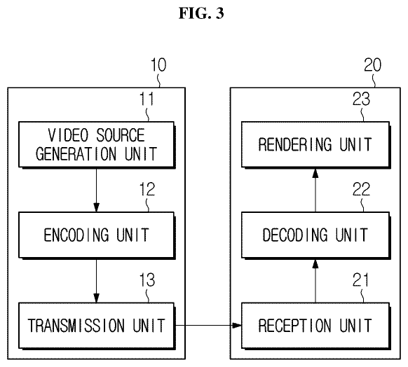

FIG. 3 is a diagram schematically showing a video coding system to which the present disclosure is applicable.

A video coding system according to an embodiment may include an encoding apparatus 10 and a decoding apparatus 20. The encoding apparatus 10 may transmit encoded video and/or image information or data to the decoding apparatus 20 in the form of a file or streaming through a digital storage medium or a network.

The encoding apparatus 10 according to an embodiment may include a video source generation unit 11, an encoding unit 12, and a transmission unit 13. The decoding apparatus 20 according to an embodiment may include a reception unit 21, a decoding unit 22, and a rendering unit 23. The encoding unit 12 may be called a video/image encoding unit, and the decoding unit 22 may be called a video/image decoding unit. The transmission unit 13 may be included in the encoding unit 12. The reception unit 21 may be included in the decoding unit 22. The rendering unit 23 may include a display unit, and the display unit may be configured as a separate device or an external component.

The video source generation unit 11 may obtain the video/image through a process of capturing, synthesizing, or generating the video/image. The video source generation unit 11 may include a video/image capture device and/or a video/image generation device. The video/image capture device may include, for example, one or more cameras, a video/image archive including previously captured video/image, etc. The video/image generation device may include, for example, a computer, a tablet, and a smartphone, etc., and may (electronically) generate the video/image. For example, a virtual video/image may be generated through a computer, etc., in which case the video/image capture process may be replaced with a process of generating related data.

The encoding unit 12 may encode the input video/image. The encoding unit 12 may perform a series of procedures such as prediction, transform, and quantization for compression and encoding efficiency. The encoding unit 12 may output encoded data (encoded video/image information) in the form of a bitstream. The detailed configuration of the encoding unit 12 may also be configured in the same manner as the encoding apparatus 100 of FIG. 1 described above.

The transmission unit 13 may transmit encoded video/image information or data output in the form of a bitstream to the reception unit 21 of the decoding apparatus 20 through a digital storage medium or a network in the form of a file or streaming. The digital storage medium may include various storage media such as USB, SD, CD, DVD, Blu-ray, HDD, SSD, etc. The transmission unit 13 may include an element for generating a media file through a predetermined file format and may include an element for transmission through a broadcasting/communication network. The reception unit 21 may extract/receive the bitstream from the storage medium or the network and transmit it to the decoding unit 22.

The decoding unit 22 may decode the video/image by performing a series of procedures such as dequantization, inverse transform, and prediction corresponding to the operation of the encoding unit 12. The detailed configuration of the decoding unit 22 may also be configured in the same manner as the above-described decoding apparatus 200 of FIG. 2.

The rendering unit 23 may render the decoded video/image. The rendered video/image may be displayed through the display unit.

In the present disclosure, various embodiments of geometric partitioning mode (GPM) are described. According to geometric partitioning mode, a block is partitioned into two partitions by a linear split boundary, each of the two resulting partitions is independently predicted by a different prediction method, and thus a prediction block is generated for each partition. In addition, a final prediction block of geometric partitioning mode is generated by forming a weighted sum of prediction signals of the prediction blocks for each partition.

Herein, in order to enhance prediction accuracy of geometric partitioning mode, not only intra prediction mode but also intra block copy (IBC) mode or intra template matching (IntraTMP) mode may be applied to each resulting partition according to geometric partitioning mode.

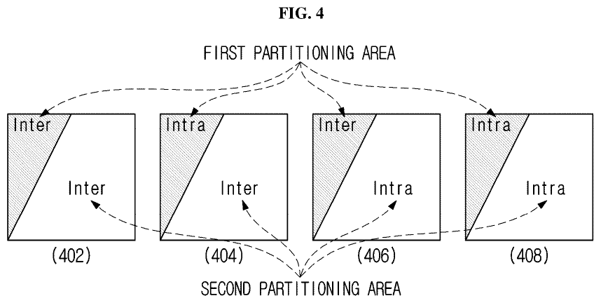

FIG. 4 shows combination of intra prediction and inter prediction that may occur in geometric partitioning mode.

According to an embodiment, two partitions resulting from geometric partitioning mode may each be independently predicted by intra prediction or inter prediction.

An inter-inter prediction combination is applied to a block 402 of FIG. 4. According to the prediction combination, two partitions may be independently predicted according to different information. Herein, unidirectional motion compensation is performed for each of the partitions.

An intra-inter prediction combination is applied to a block 404 and a block 406 of FIG. 4. According to the prediction combination, one of the two partitions is predicted according to intra prediction, and the other one is predicted according to inter prediction. Herein, for the partition using inter prediction, unidirectional motion compensation is performed, and the partition using intra prediction is predicted based on an intra prediction mode.

An intra-intra prediction combination is applied to a block 408 of FIG. 4. According to the prediction combination, two partitions are independently predicted based on different intra prediction modes.

Herein, the intra prediction modes include regular intra prediction mode, intra template matching mode, and intra block copy mode. In addition, the regular intra prediction mode includes DC mode, planar mode, and angular mode, which use a reference sample adjacent to a current block.

According to an embodiment, the intra-inter prediction combination may be implemented as a combination of a regular intra prediction mode and an inter prediction mode, a combination of an intra template matching mode and an inter prediction mode, or a combination of an intra block copy mode and an inter prediction mode.

According to an embodiment, the intra-intra prediction combination may be implemented as a combination of different regular intra prediction modes, a combination of intra block copy modes based on different block vectors, a combination of intra template matching modes based on different templates, a combination of a regular intra prediction mode and an intra block copy mode, a combination of a regular intra prediction mode and an intra template matching mode, or a combination of an intra block copy mode and an intra template matching mode.

Hereinafter, a method for using intra template matching in a geometric partitioning mode will be described.

As for intra prediction applied to a partition in a geometric partitioning mode, a method for performing prediction of the partition by using intra template matching is proposed. Intra template matching may be applied to the blocks 404, 406 and 408 of FIG. 4 for which intra prediction is applied.

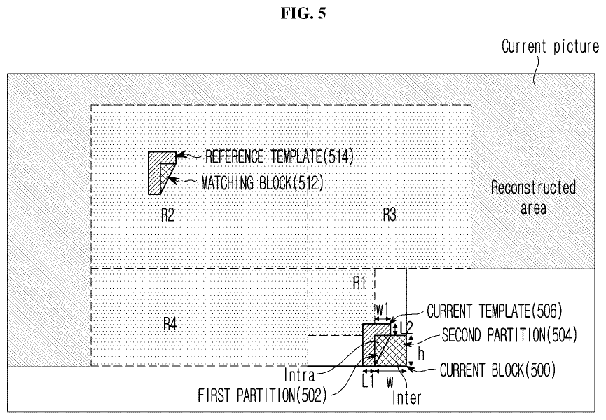

FIG. 5 to FIG. 8 describe various template examples for intra template matching of a partition including an upper-left sample.

FIG. 5 shows a method for generating a prediction block according to an intra template matching mode of a partition in geometric partitioning mode.

According to FIG. 5, a current block 500 is partitioned by a linear split boundary into a first partition 502, which includes an upper-left vertex sample, and a second partition 504 that does not include the sample. Herein, the first partition 502 is encoded by an intra template matching mode, which is a type of intra prediction method, and the second partition 504 is encoded by inter prediction.

For intra template matching of the first partition 502, an L-shaped current template 506 consisting of a reference sample adjacent to the first partition 502 is defined. In addition, a reference template 514, which is most similar to the current template 506, is searched in a reconstructed area. In addition, a block corresponding to the reference template 514 may be selected as a prediction block 512.

According to an embodiment, an area in which a reference template is searched may be limited to a predefined search range. Alternatively, the predefined search range may be composed of some or all of R1, R2, R3 and R4. Herein, R1 is defined as a current coding tree block, R2 is defined as an upper-left coding tree block of the current coding tree block, R3 is defined as an upper coding tree block of the current coding tree block, and R4 is defined as a left coding tree block of the current coding tree block. However, this is one example, and R1, R2, R3 and R4 may be defined by any other size and positions. In addition, a search range may include not only R1, R2, R3 and R4 but also any other blocks.

If an area in which a reference template is searched is expanded, a probability of finding a reference template similar to a current template may increase, but an amount of computation for finding a reference template may also increase. On the other hand, if an area in which a reference template is searched is reduced, a probability of finding a reference template similar to a current template may decrease, but an amount of computation for finding a reference template may decrease.

According to an embodiment, if a current block is in geometric partitioning mode and intra prediction is performed for a partition of the current block, information on an intra prediction mode applied to the partition may be encoded. In addition, the encoded information may be transmitted to a decoder, and the decoder may apply an intra template matching mode to the partition according to the information.

According to an embodiment, a size (L1×h+w1×L2+L1×L2) of a-shaped template adjacent to the current block 500 may also be arbitrarily determined. Here, w and h represent a horizontal length and a vertical length of the current block 500, respectively. In addition, L1 and L2 represent a left width and an upper width of the current template 506, respectively. In addition, w1 represents a horizontal length of the first partition 502. Here, w, h, L1, L2 and w1 are arbitrary positive integers. Here, w and h are the width and height of a current block, and L1, L2 and w1 are arbitrary positive integers.

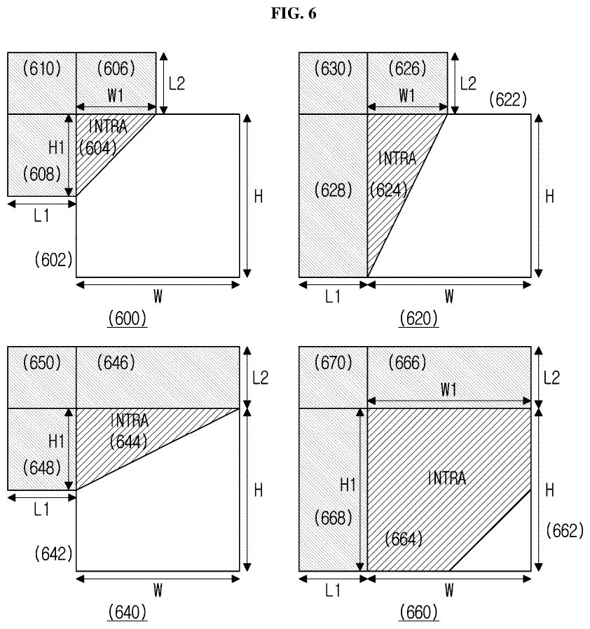

FIG. 6 shows an embodiment of a template including left, upper, and upper-left reference samples for intra template matching of a partition including an upper-left sample of a block.

FIG. 6 illustrates templates of four embodiments 600, 620, 640 and 660 according to a partitioning method of a partition.

In Embodiments 1 to 4 600, 620, 640 and 660, a current block is composed of two partitions, and intra template matching is applied to a partition that includes an upper-left sample. In addition, a template of each embodiment is composed of an upper region, a left region, and an upper-left region. A left region is positioned to the left side of an intra template matching partition and is determined by a left height (H1 or H) of the intra template matching partition and a width L1 of a template. An upper region is positioned above an intra template matching partition and is determined by an upper width (W1 or W) of the intra template matching partition and a width L2 of a template. An upper-left region is positioned at the upper-left of an intra template matching partition and is determined by widths L1 and L2 of the intra template matching partition.

According to Embodiment 1 600, based on a partition split, an upper width W1 of a partition 604 is determined to be less than a width W of a current block 602, and a left height H1 of the partition 604 is determined to be less than a height H of the current block 602. Accordingly, a template of Embodiment 1 600 is composed of an upper region (W1×L2) 606, a left region (L1×H1) 608 and an upper-left region (L1×L2) 610 of the partition 604.

According to Embodiment 2 620, based on a partition split, an upper width W1 of a partition 624 is determined to be less than a width W of a current block 622, and a left height H1 of the partition 624 is determined to be equal to a height H of the current block 622. A template of Embodiment 2 620 is composed of an upper region (W1×L2) 626, a left region (L1×H) 628 and an upper-left region (L1×L2) 630 of the partition 624. In addition, irrespective of a split boundary of a partition, the height and size of the left region 628 are constantly H and L1×H, respectively.

According to Embodiment 3 640, based on a partition split, an upper width W1 of a partition 644 is determined to be equal to a width W of a current block 642, and a left height H1 of the partition 644 is determined to be less than a height H of the current block 642. A template of Embodiment 3 640 is composed of an upper region (W1×L2) 646, a left region (L1×H1) 648 and an upper-left region (L1×L2) 650 of the partition 644. In addition, irrespective of a split boundary of a partition, the width and size of the upper region 646 are constantly W and W×L2, respectively.

According to Embodiment 4 660, based on a partition split, an upper width W1 of a partition 664 is determined to be equal to a width W of a current block 662, and a left height H1 of the partition 664 is determined to be equal to a height H of the current block 662. Accordingly, a template of Embodiment 4 660 is composed of an upper region (W1×L2) 666, a left region (L1×H1) 668 and an upper-left region (L1×L2) 670 of the partition 664. In addition, irrespective of a partition boundary of a partition, the width and size of the upper region 666 are constantly W and W×L2, respectively. In addition, irrespective of a split boundary of a partition, the height and size of the left region 668 are constantly H and L1×H, respectively. That is, all regions of a template are constant irrespective of a split boundary of a partition.

In each embodiment of FIG. 6, a template is described to include all of an upper region, a left region, and an upper-left region, but according to an embodiment, a template may include only an upper region or a left region. For example, when a current block is adjacent to an upper boundary of a picture or slice, a template may include only a left region. On the other hand, when a current block is adjacent to a left boundary of a picture or slice, a template may include only an upper region. In addition, depending on whether there is a reference sample corresponding to each region, a region included in a template may be determined. Alternatively, irrespective of a current block, a region included in a template may be determined according to prediction accuracy.

Here, W and H are the width and height of a current block, and W1, H1, L1 and L2 are arbitrary positive integers.

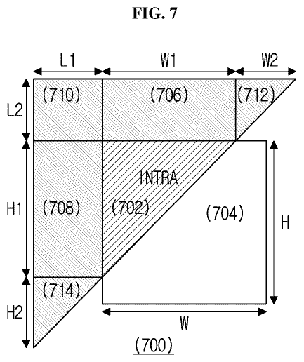

FIG. 7 shows an embodiment of a template including not only left, upper and upper-left reference samples but also reference samples of a region determined according an extended split boundary.

A current block 700 is composed of a partition 702 and an inter partition 704. In addition, a template is composed of an upper region 706, an upper-left region 710, an upper-right region 712, and a lower-left region 714. The upper-right region 712 is positioned to the right side of the upper region 706 and is determined by an extended split boundary. In addition, the lower-left region 714 is positioned below the left region 708 and is determined by the extended split boundary. According to a split boundary, the upper region 706, the left region 708 and the upper-left region 710 of FIG. 7 may be determined by the same method that determines the upper regions 606, 626, 646 and 666, the left regions 608, 628, 648 and 668 and the upper-left regions 610, 630, 650 and 670 of FIG. 6.

The upper-right region ((W2×L2)/2) 712 is determined by an upper-right region width W2 and an upper width L2 of the template. The upper-right region width W2 is determined by the extended split boundary and the upper width L2. In addition, the lower-left region ((L1×H2)/2) 714 is determined by a lower-left region height H2 and a left width L1 of the template. The lower-left region height H2 is determined by the extended split boundary and the left width L1 of the template.

According to the split boundary of the current block 700, the upper-right region 712 and the lower-left region 714 are added to the template so that the range of the template is expanded. As the range of the template is expanded based on the split boundary, prediction accuracy of a reference block according to template matching may be improved.

In FIG. 7, the upper region 706, the left region 708, the upper-left region 710, the upper-right region 712 and the lower-left region 714 are all described to be included in the template, but according to an embodiment, the template may include only some of the five regions. For example, if the current block 700 is positioned at the top of a picture or slice, the template may include only the left region 708 and the lower-left region 714. On the other hand, if the current block 700 is positioned at the leftmost end of a picture or slice, the template may include only the upper region 706 and the upper-right region 712. In addition, depending on whether there is a reference sample corresponding to each region, a region included in a template may be determined. Alternatively, irrespective of the current block 700, a region included in the template may be determined according to prediction accuracy.

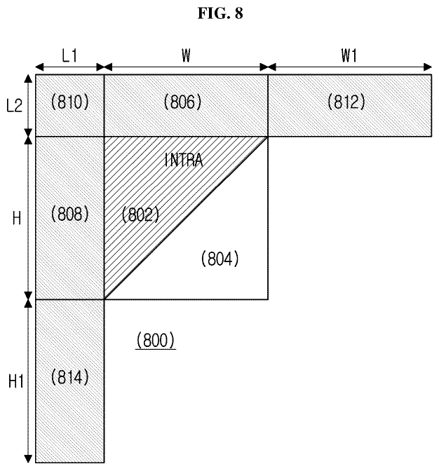

FIG. 8 shows an embodiment of a template including not only left, upper and upper-left reference samples but also lower-left and upper-right reference samples.

A current block 800 is composed of a partition 802 and an inter partition 804. In addition, a template is composed of an upper region 806, a left region 808, an upper-left region 810, an upper-right region 810, and a lower-left region 814. In addition, irrespective of a partitioning method of the current block 800, the five regions are determined by a size of the current block 800.

The upper region (W×L2) 806 is determined by a width W of the current block 800 and an upper width L2 of the template. The left region (L1×H) 808 is determined by a height H of the current block 800 and a left width L1 of the template. The upper-left region (L1×L2) 810 is determined by the left width L1 and the upper width L2 of the template.

The upper-right region 812 is determined by a random value W1 and the upper width L2 of the template. Here, W1 may be determined based on the value of W. For example, W1 may be N times as large as W. N may have a value such as 1, ½, ¼, . . . , ½k. Alternatively, W1 may have a fixed value. Alternatively, W1 may be determined according to a partitioning method of the current block 800. For example, as the upper width of the partition 802 becomes larger, W1 may increase.

In addition, the lower-left region 814 is determined by a random value H1 and the left width L1 of the template. Here, H1 may be determined based on the value of H. For example, H1 may be N times as large as H. N may have a value such as 1, ½, ¼, . . . , ½k. Alternatively, H1 may have a fixed value. Alternatively, H1 may be determined according to a partitioning method of the current block 800. For example, as the left height of the partition 802 becomes larger, H1 may increase.

Prediction accuracy of a reference block according to template matching may be improved by expanding the range of the template of the partition 802 to all reference blocks around the current block 800.

In FIG. 8, the upper region, the left region, the upper-left region, the lower-left region, and the upper-right region are all described to be included in the template, but according to an embodiment, the template may include only some of the five regions. For example, when a current block is positioned at the top of a picture or slice, the template may include only the left region and the lower-left region. On the other hand, when a current block is positioned at the leftmost end of a picture or slice, the template may include only the upper region and the upper-right region. In addition, depending on whether there is a reference sample corresponding to each region, a region included in a template may be determined. Alternatively, irrespective of a current block, a region included in a template may be determined according to prediction accuracy.

A template with an arbitrary shape, which is not described in FIG. 6 to FIG. 8, may be used for intra template matching. In addition, in FIG. 6 to FIG. 8, if a partition including an upper-left sample is in intra template matching mode, a method of determining a shape of template is described, but if another partition not including the upper-left sample is also in intra template matching mode, the shape of the template may be determined in the same method.

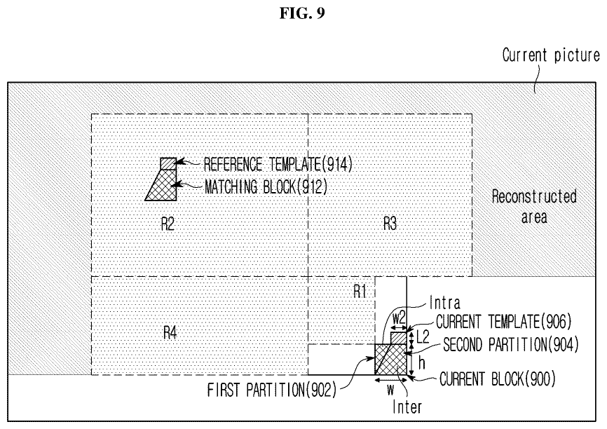

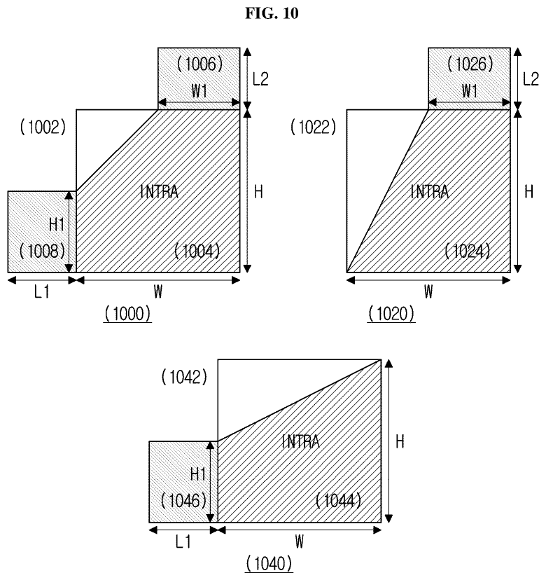

FIG. 9 to FIG. 10 describe various template examples for intra template matching of a partition that does not include an upper-left sample.

FIG. 9 shows a method for predicting a second partition of a current block according to intra template matching mode.

In FIG. 9, a current block 900 is in geometric partitioning mode and is partitioned by a linear split boundary into a first partition 902, which includes an upper-left vertex sample, and a second partition 904 that does not include the sample. Herein, the second partition 904 is encoded by an intra template matching mode, which is a type of intra prediction method, and the first partition 902 is encoded by inter prediction.

For intra template matching of the second partition 904, a rectangular current template 906 consisting of a reference sample adjacent to the second partition 904 is defined. In addition, a reference template 914, which is most similar to the current template 906, is searched in a reconstructed area. In addition, a block corresponding to the reference template 914 may be selected as a prediction block 912. An area where the reference template of FIG. 9 is searched may be limited to the search range described in FIG. 5.

According to an embodiment, the size (w2×L2) and shape of a rectangular template adjacent to the current block 900 may also be arbitrarily determined. Herein, w2 represents an upper height of the second partition 904, and L2 represents an upper width of the current template 906. Here, w2 and L2 are arbitrary positive integers.

FIG. 10 shows an embodiment of a template including left and upper reference samples for intra template matching of a partition not including an upper-left sample of a block.

FIG. 10 illustrates templates of four embodiments 1000, 1020 and 1040 according to a partitioning method of a partition.

In Embodiments 1 to 3 1000, 1020 and 1040, a current block is composed of two partitions, and intra template matching is applied to a partition that does not include an upper-left sample. A template of each embodiment includes at least one of an upper region and a left region according to a partitioning method. A left region is positioned to the left side of an intra template matching partition and is determined by a left height H1 of the intra template matching partition and a width L1 of a template. An upper region is positioned above an intra template matching partition and is determined by an upper width W1 of the intra template matching partition and a width L2 of a template. The upper width W1 of a partition is determined to be less than a width W of a current block, and the left height H1 of the partition is determined to be less than a height H of the current block.

According to Embodiment 1 1000, according to partition split, a portion of a boundary of a partition 1004 overlaps with a portion of an upper boundary of a current block 1002 and with a portion of a left boundary of the current block 1002. Accordingly, a template of Embodiment 1 1000 is composed of an upper region (W1×L2) 1006 and a left region (L1×H1) 1008 of the partition 1004.

According to Embodiment 2 1020, according to partition split, a portion of a boundary of a partition 1024 overlaps with a portion of an upper boundary of a current block 1022. Accordingly, a template of Embodiment 2 1020 is composed of an upper region (W1×L2) 1026 of the partition 1024.

According to Embodiment 3 1040, according to partition split, a portion of a boundary of a partition 1044 overlaps with a portion of a left boundary of a current block 1042. Accordingly, a template of Embodiment 3 1040 is composed of a left region (L1×H1) 1046.

Hereinafter will be described a method for determining a prediction method of two partitions of a block in which intra template matching is allowed for a partition.

If both the first partition and second partition of a current block are predicted by intra prediction, an intra template matching mode may be applied for one or more of the two partitions. Herein, in an encoder, information indicating which mode of a regular intra prediction mode and an intra template matching mode is applied to the first partition may be encoded. Likewise, in the encoder, information indicating which mode of a regular intra prediction mode and an intra template matching mode is applied to the second partition may be encoded. The information may be transmitted to a decoder and be decoded in the decoder.

According to an embodiment, an intra template matching mode may be applied to only one of the first partition or the second partition. Accordingly, an intra template matching mode may be applied to only one of the first partition and the second partition, and a regular intra prediction mode may be applied to the other partition. If an intra template matching mode is applied to only one partition, an encoder may encode and transmit information indicating a partition, to which the intra template matching mode is applied, and information on a regular intra prediction mode for a partition to which no intra template matching mode is applied. In addition, the information is parsed in a decoder.

Based on information on a regular intra prediction mode of a partition, whether intra template matching is performed may be determined. For example, if a predetermined mode is applied to a partition to which a regular intra prediction mode is applied, a regular intra prediction mode may be applied to the other partition instead of an intra template matching mode. On the other hand, if a predetermined mode is not applied to a partition to which a regular intra prediction mode is applied, an intra template matching mode may be applied to the other partition. The predetermined mode may include planar mode, DC mode, horizontal mode, or vertical mode. Alternatively, the predetermined mode may include another regular intra prediction mode.

According to an embodiment, an intra template matching mode may be applied to both the first partition and second partition of a current block. Herein, for each partition, an encoder may encode and transmit information indicating whether the intra template matching mode is individually applied. In addition, a decoder may decode the information of each partition. In addition, if the intra template matching mode is applied to both the first partition and second partition of the current block, a template of the first partition and a template of the second partition may be determined not to overlap with each other or to have a minimum overlapping area.

According to an embodiment, according to a partitioning method of the current block, whether the intra template matching mode is applied to the first partition and the second partition may be determined. For example, for a partition that is not adjacent to an upper boundary or left boundary of the current block, it may be determined that the intra template matching mode is not applied. Alternatively, according to how much the upper boundary and left boundary of the current block overlap with a boundary of a partition, whether the intra template matching mode is applied to the partition may be determined. Alternatively, according to whether a partition includes a sample at a specific location of the current block, whether the intra template matching mode is applied to the partition may be determined. Alternatively, according to the horizontal length, vertical length, aspect ratio and/or size of a specific split partition (e.g., a small-sized partition), whether the intra template matching mode is applied may be determined.

The method proposed in this embodiment may be applied according to a size of a block. For example, the proposed method may be applied only when a horizontal length and/or a vertical length of a block is equal to or greater than a predetermined value (e.g., 4) or/and is equal to or less than a predetermined value (e.g., 64). Alternatively, the proposed method may be applied only when a width of a block is less than a predetermined integer multiple of a height. On the other hand, the proposed method may be applied only when a height of a block is less than a predetermined integer multiple of a width. Alternatively, according to an embodiment, the proposed method may be applied only when a product of the horizontal length and vertical length of a block is equal to or greater than an arbitrary value (e.g., 32).

Hereinafter, a method for applying intra block copy in geometric partitioning mode will be described.

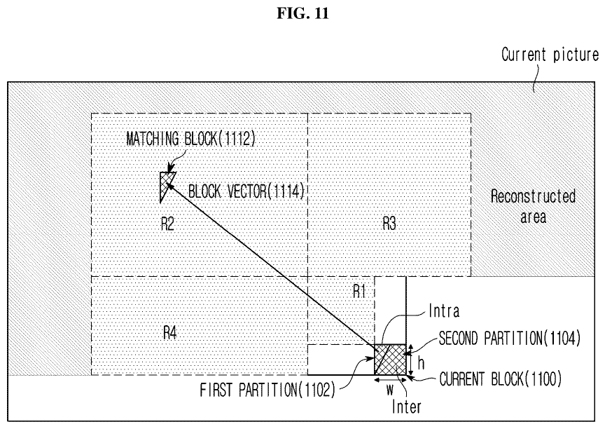

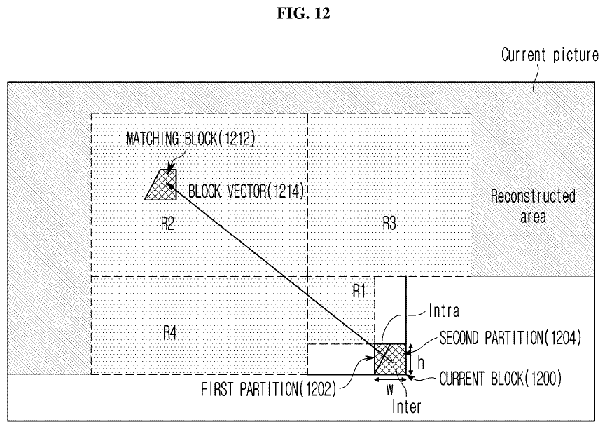

FIG. 11 to FIG. 12 describe an intra block copy mode applied to a geometric partitioning mode.

FIG. 11 describes a method for predicting a partition according to intra block copy mode in geometric partitioning mode.

Intra block copy mode may be used in the remaining prediction combinations excluding the inter-inter prediction combination in FIG. 4. According to FIG. 11, a current block 1100 is partitioned into a first partition 1102 and a second partition 1104. Herein, the first partition 1102 is encoded by an intra block copy mode, which is a type of intra prediction method, and the second partition 1104 is encoded by inter prediction.

In a reconstructed area, an encoder searches for a matching block 1112 that is most similar to the first partition 1102. In addition, the most similar matching block 1112 may be selected as a prediction block of the first partition 1102.

According to an embodiment, an area in which the matching block 1112 is searched may be limited to a predefined search range. Alternatively, the predefined search range may be composed of some or all of R1, R2, R3 and R4. Herein, R1 is defined as a current coding tree block, R2 is defined as an upper-left coding tree block of the current coding tree block, R3 is defined as an upper coding tree block of the current coding tree block, and R4 is defined as a left coding tree block of the current coding tree block. However, this is one example, and R1, R2, R3 and R4 may be defined by any other size and position. In addition, a search range may include not only R1, R2, R3 and R4 but also any other blocks.

An intra block copy mode is performed based on a block vector 1114. Accordingly, block vector information is transmitted and parsed by an encoder. In addition, based on the block vector information, a decoder may predict a predetermined partition according to the intra block copy mode.

In FIG. 11, an intra block copy mode is applied to a first partition, but according to an embodiment, the intra block copy mode may be applied to a second partition in the same method as described above.

FIG. 12 shows a method for predicting a second partition of a current block according to intra block copy mode.

In FIG. 12, a current block 1200 is in geometric partitioning mode and is partitioned by a linear split boundary into a first partition 1202, which includes an upper-left vertex sample, and a second partition 1204 that does not include the sample. Herein, the second partition 1204 is encoded by an intra block copy mode, which is a type of intra prediction method, and the first partition 1202 is encoded by inter prediction.

In a reconstructed area, an encoder searches for a matching block 1212 that is most similar to the second partition 1204. In addition, the most similar matching block 1212 may be selected as a prediction block of the second partition 1204. Herein, a search range of the matching block 1212 may be limited to the search range described in FIG. 11.

In FIG. 11 and FIG. 12, a geometric partitioning mode, to which an intra block copy mode is applicable, is performed based on a block vector. Accordingly, block vector information should be encoded and transmitted by an encoder. In addition, a decoder may perform intra block copy of a partition according to the block vector information.

If both the first partition and second partition of a current block are predicted by intra prediction, an intra block copy mode may be applied for one or more of the two partitions. Herein, in an encoder, information indicating which mode of a regular intra prediction mode and an intra block copy mode is applied to the first partition may be encoded. Likewise, in the encoder, information indicating which mode of a regular intra prediction mode and an intra block copy mode is applied to the second partition may be encoded. The information may be transmitted to a decoder and be decoded in the decoder.

According to an embodiment, an intra block copy mode may be applied to only one of the first partition or the second partition. Accordingly, an intra block copy mode may be applied to only one of the first partition and the second partition, and an intra prediction mode may be applied to the other partition. If an intra block copy mode is applied to only one partition, an encoder may encode and transmit information indicating a partition, to which the intra block copy mode is applied, and information on a regular intra prediction mode for a partition to which no intra block copy mode is applied. In addition, the information is parsed in a decoder.

Based on information on a regular intra prediction mode of a partition to which the regular intra prediction mode is applied, whether intra block copy is performed may be determined. For example, if an intra prediction mode of a partition, to which the intra prediction mode is applied, is a predetermined mode, an intra prediction mode may be applied to the other partition instead of an intra block copy mode. On the other hand, if an intra prediction mode of a partition, to which the intra prediction mode is applied, is not a predetermined mode, an intra block copy mode may be applied to the other partition. The predetermined mode may include planar mode, DC mode, horizontal mode, or vertical mode. Alternatively, the predetermined mode may include another intra prediction mode.

According to an embodiment, an intra block copy mode may be applied to both the first partition and second partition of a current block. Herein, for each partition, an encoder may encode and transmit information indicating whether the intra block copy mode is individually applied. In addition, for a partition to which the intra block copy mode is applied, the encoder may encode and transmit block vector information of each partition. In addition, a decoder may decode the information of each partition.

According to an embodiment, if a current block is in geometric partitioning mode and an intra block copy mode is applied to a partition of the current block, information on a prediction method of each partition may be parsed (transmitted) as follows. First, by parsing information on a first partition (first partition flag), a prediction mode for the first partition is determined out of a regular intra prediction mode and an intra block copy mode. If the first partition is in the regular intra prediction mode, information on the second partition (second partition flag) is not parsed, and a prediction mode of the second partition is determined as intra block copy mode. If the first partition is in intra block copy mode, by parsing the information on the second partition (second partition flag), a prediction mode for the second partition is determined out of a regular intra prediction mode and an intra block copy mode. Herein, for a partition to which an intra block copy mode is applied, block vector information for the partition may be additionally parsed.

According to an embodiment, if a current block is in geometric partitioning mode and an intra block copy mode is applied to a partition of the current block, a parsing (transmission) method is as follows. By parsing information on a first partition (first partition flag), a prediction mode for the first partition is determined out of a regular intra prediction mode and an intra block copy mode. In addition, independently of the first partition, by parsing information on a second partition (second partition flag), a prediction mode for the second partition is determined out of a regular intra prediction mode and an intra block copy mode. Herein, for a partition to which an intra block copy mode is applied, block vector information for the partition may be additionally parsed.

The method proposed in this embodiment may be applied according to a size of a block. For example, the proposed method may be applied only when a horizontal length and/or a vertical length of a block is equal to or greater than an arbitrary value (e.g., 4) or/and is equal to or less than an arbitrary value (e.g., 64). Alternatively, the proposed method may be applied only when a width of a block is less than a predetermined integer multiple of a height. On the other hand, the proposed method may be applied only when a height of a block is less than a predetermined integer multiple of a width. Alternatively, according to an embodiment, the proposed method may be applied only when a product of the horizontal length and vertical length of a block is equal to or greater than an arbitrary value (e.g., 32).

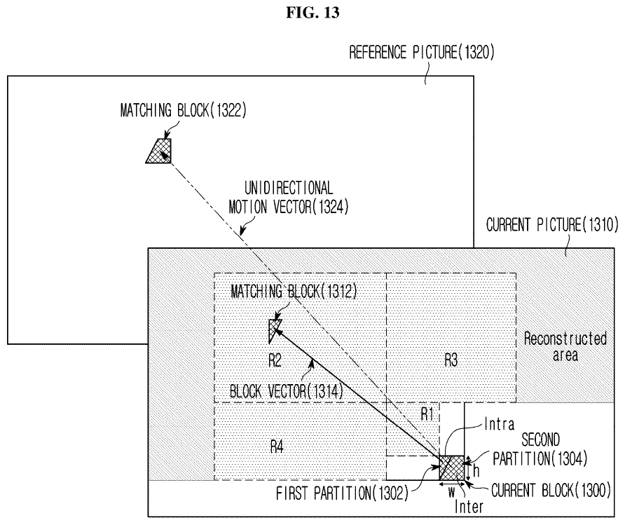

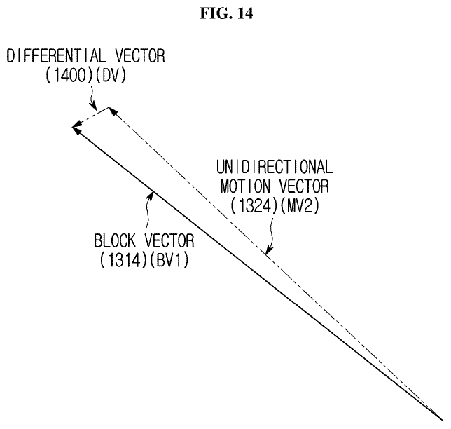

In FIG. 13 to FIG. 14, a method for efficiently transmitting/parsing block vector information of an intra block copy mode in geometric partitioning mode is described.

In geometric partitioning mode, if an intra block copy mode is applied to one or more partitions, block vector information for a partition should be efficiently encoded. Herein, if an amount of the encoded block vector information is large, coding efficiency may be reduced. Accordingly, in an embodiment below, a method for efficiently encoding a block vector will be described.

FIG. 13 shows a method for generating a prediction block based on intra block copy for a region in which intra prediction is performed in geometric partitioning mode.

In FIG. 13, a current picture 1310 is a picture at time t, and a reference picture 1320 is a picture at time t-N. Herein t and N are arbitrary positive integers, 0≤t−N<t. In FIG. 13, the reference picture 1320 is temporally located prior to the current picture 1310, but this is merely one example, and the reference 1320 may be temporally located after the current picture 1310.

In FIG. 13, a current block 1300 is in geometric partitioning mode and is partitioned by a linear split boundary into a first partition 1302 and a second partition 1304. Herein, intra prediction may be applied to the first partition 1302, and inter prediction may be applied to the second partition 1304. A unidirectional motion vector 1324 of the second partition 1304, to which inter prediction is applied, is MV2. In addition, a block vector 1314 of the first partition 1302, to which intra prediction is applied, is BV1. In order to reduce a size of information on the block vector 1314 of the first partition 1302, the unidirectional motion vector 1324 of the second partition 1304 may be referenced.

FIG. 14 shows a method for reducing a size of information of a block vector by using a unidirectional motion vector.

In FIG. 14, the dotted line represents the unidirectional motion vector MV2 1324 of FIG. 13, and the solid line represents the block vector BV1 1314 of FIG. 13. The unidirectional motion vector MV2 1324 and the block vector BV1 1314 are possible to be similar to each other. Accordingly, considering this characteristic, instead of independently encoding the block vector BV1 1314 and the unidirectional motion vector MV2 1324, it is possible to encode the unidirectional motion vector MV2 1324 and a differential vector DV 1400 between the unidirectional motion vector MV2 1324 and the block vector BV1 1314. Thus, a size of block vector information to be transmitted to a decoder may be efficiently reduced. Equation 1 shows a method of calculating vector difference DV.

$$\begin{matrix}{DV}_{x} = MV {2}_{x} - BV {1}_{x} \\ {DV}_{y} = MV {2}_{y} - BV {1}_{y}\end{matrix} \qquad [ Equation 1 ]$$

In Equation 1, MV2x, BV1x and DVx represent an x component of a unidirectional motion vector, an x component of a block vector, and a difference between the x component of the unidirectional motion vector and the x component of the block vector, respectively. In Equation 1, MV2y, BVly and DVy represent a y component of a unidirectional motion vector, a y component of a block vector, and a difference between the y component of the unidirectional motion vector and the y component of the block vector, respectively.

Contrary to the above embodiment, the block vector BV1 1314 and the differential vector DV 1400 between the block vector BV1 1314 and the unidirectional motion vector MV2 1324 may be encoded.

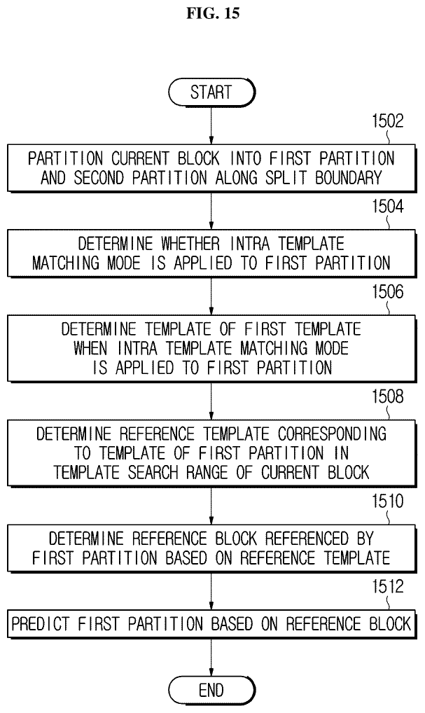

FIG. 15 shows an embodiment of a prediction method according to geometric partitioning mode in which intra template matching mode is applied.

At step S1502, a current block is partitioned into a first partition and a second partition along a split boundary.

At step S1504, whether an intra template matching mode is applied to the first partition is determined.

According to an embodiment, one of an inter prediction mode, an intra prediction mode, an intra block copy mode, and an intra template matching mode may be applied to each of the first partition and the second partition. Prediction methods applied to the first partition and the second partition may be determined independently of each other.

According to an embodiment, a prediction method of the second partition may be determined according to a prediction method of the first partition, or a prediction method of the first partition may be determined according to a prediction method of the second partition. For example, when an intra template matching mode is applied to the first partition and an intra prediction mode is applied to the second partition, the second partition may be predicted by one of predetermined intra prediction methods. On the other hand, when the intra template matching mode is not applied to the first partition and the intra prediction mode is applied to the second partition, the second partition may be predicted by one of prediction methods not included in the predetermined intra prediction methods. The predetermined intra prediction methods may include at least one of planar mode, DC mode, horizontal mode, or vertical mode. As another example, when the intra template matching mode is applied to the first partition and a regular intra prediction mode is applied to the second partition, the second partition may be predicted by regular intra prediction modes.

According to an embodiment, when the intra template matching mode is applied to both the first partition and the second partition, a template of the first partition and a template of the second partition may be configured not to be identical to each other.

At step S1506, when the intra template matching mode is applied to the first partition, the template of the first partition is determined.

According to an embodiment, the first partition may include an upper-left sample of the current block, and the template of the first partition may include at least one of a left region positioned to the left side of the first partition, an upper region positioned above the first partition, and an upper-left region positioned at the upper-left of the first partition.

According to an embodiment, if the current block is adjacent to an upper boundary of a slice or picture including the current block, the template may not include the upper region and the upper-left region but include the left region. On the other hand, if the current block is adjacent to a left boundary of the slice or picture including the current block, the template may not include the left region and the upper-left region but include the upper region.

According to an embodiment, a width of the upper region of the template may be configured to be identical to an upper-side width of the first partition, and a height of the left region of the template may be configured to be identical to a left height of the first partition. Alternatively, the width of the upper region of the template may be configured to be identical to a width of the current block, and the height of the left region of the template may be configured to be identical to a height of the current block.

According to an embodiment, the template of the first partition may further include at least one of a lower-left region adjacent to a lower side of the left region and an upper-right region adjacent to a right side of the upper region. In addition, the lower-left region and the upper-right region may be determined according to an extended split boundary of the current block.

According to an embodiment, the lower-left region may be determined to be adjacent in a lower-left direction from a lower-left vertex of the current block, and the upper-right region may be determined to be adjacent in an upper-right direction from an upper-right vertex of the current block.

According to an embodiment, the first partition may include the upper-left sample of the current block.

According to an embodiment, the first partition may not include the upper-left sample of the current block but be adjacent to at least one of a left boundary and an upper boundary of the current block, and when the first partition is adjacent to the left boundary of the current block, the template of the first partition may include the left region positioned to the left side of the first partition, and when the first partition is adjacent to the upper boundary of the current block, the template of the first partition may include the upper region positioned above the first partition.

At step S1508, a reference template corresponding to the template of the first partition is determined in a template search range of the current block.

At step S1510, a reference block referenced by the first partition is determined based on the reference template.

At step S1512, the first partition is predicted based on the reference block.

According to the prediction method performed at step S1502 to step S1512, the current block may be encoded or decoded. A bitstream generated by an encoder according to the prediction method performed at step S1502 to step S1512 may be stored in a recoding medium or transmitted outside the encoder. If an intra template matching mode is applied to the second partition, the method of FIG. 15 may be applied not only to the first partition but also to the second partition.

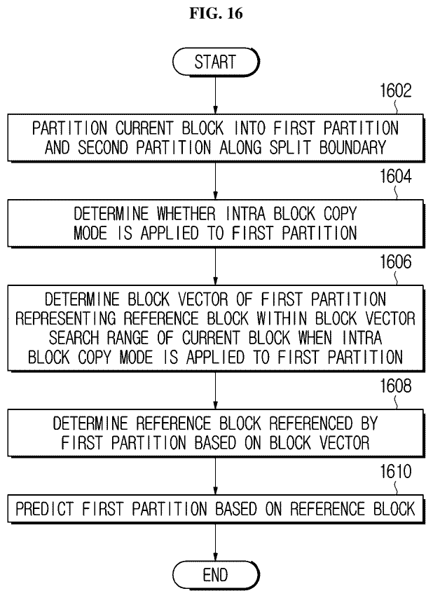

FIG. 16 shows an embodiment of a prediction method according to geometric partitioning mode in which intra block copy mode is applied.

At step S1602, a current block is partitioned into a first partition and a second partition along a split boundary.

At step S1604, whether an intra block copy mode is applied to the first partition is determined.

According to an embodiment, one of an inter prediction mode, an intra prediction mode, an intra block copy mode, and an intra template matching mode may be applied to each of the first partition and the second partition. Prediction methods applied to the first partition and the second partition may be determined independently of each other. Based on a first partitioning area flag, whether an intra block copy mode is applied to the first partition may be determined. In addition, based on a second partitioning area flag, whether an intra block copy mode is applied to the second partition may be determined.

According to an embodiment, based on the first partitioning area flag, whether an intra block copy mode is applied to the first partition may be determined. In addition, if the intra block copy mode is not applied to the first partition, it may be determined that the intra block copy mode is applied to the second partition. On the other hand, if the intra block copy mode is applied to the first partition, whether the intra block copy mode is applied to the second partition may be determined based on the second partitioning area flag.

According to an embodiment, a prediction method of the second partition may be determined according to a prediction method of the first partition, or a prediction method of the first partition may be determined according to a prediction method of the second partition. For example, when the intra block copy mode is applied to the first partition and an intra prediction mode is applied to the second partition, the second partition may be predicted by one of predetermined intra prediction methods. On the other hand, when the intra block copy mode is not applied to the first partition and the intra prediction mode is applied to the second partition, the second partition may be predicted by one of prediction methods not included in the predetermined intra prediction methods. The predetermined intra prediction methods may include at least one of planar mode, DC mode, horizontal mode, or vertical mode. Alternatively, when the intra block copy mode is applied to the first partition and the intra prediction mode is applied to the second partition, the second partition may be predicted by regular intra prediction modes.

According to an embodiment, when the intra block copy mode is applied to both the first partition and the second partition, a block vector of the first partition and a block vector of the second partition may be configured not to be identical to each other.

At step S1606, when the intra block copy mode is applied to the first partition, the block vector of the first partition, which represents a reference block within a block vector search range of the current block, is determined.

According to an embodiment, when the intra block copy mode is applied to the first partition and the inter prediction mode is applied to the second partition, the block vector of the first partition may be derived based on a motion vector of the second partition. Herein, a differential vector, which represents difference between the block vector of the first partition and the motion vector of the second partition, may be acquired, the block vector of the first partition may be derived based on the motion vector of the second partition and the differential vector. On the other hand, the block vector of the second partition may be derived based on the motion vector of the first partition and the differential vector.

At step S1608, a reference block referenced by the first partition is determined based on the block vector.

At step S1610, the first partition is predicted based on the reference block.

According to the prediction method performed at step S1602 to step S1610, the current block may be encoded or decoded. In addition, a bitstream generated by an encoder according to the prediction method performed at step S1602 to step S1610 may be stored in a recoding medium or transmitted outside the encoder. If the intra block copy mode is applied to the second partition, the method of FIG. 16 may be applied not only to the first partition but also to the second partition.

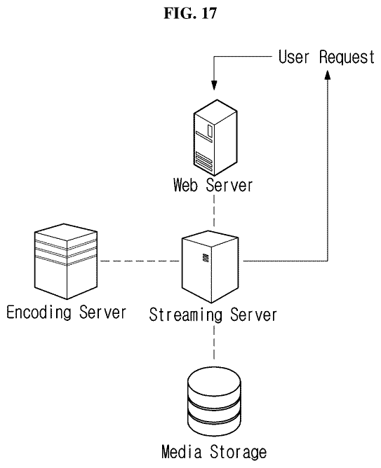

FIG. 17 exemplary illustrates a content streaming system to which an embodiment according to the present disclosure is applicable.

As illustrated in FIG. 17, a content streaming system to which an embodiment of the present disclosure is applied may largely include an encoding server, a streaming server, a web server, a media storage, a user device, and a multimedia input device.

The encoding server compresses content received from multimedia input devices such as smartphones, cameras, CCTVs, etc. into digital data to generate a bitstream and transmits it to the streaming server. As another example, if multimedia input devices such as smartphones, cameras, CCTVs, etc. directly generate a bitstream, the encoding server may be omitted.

The bitstream may be generated by an image encoding method and/or an image encoding apparatus to which an embodiment of the present disclosure is applied, and the streaming server may temporarily store the bitstream in the process of transmitting or receiving the bitstream.

The streaming server transmits multimedia data to a user device based on a user request via a web server, and the web server may act as an intermediary that informs the user of any available services. When a user requests a desired service from the web server, the web server transmits it to the streaming server, and the streaming server may transmit multimedia data to the user. At this time, the content streaming system may include a separate control server, and in this case, the control server may control commands/responses between devices within the content streaming system.

The streaming server may receive content from media storage and/or an encoding server. For example, when receiving content from the encoding server, the content may be received in real time. In this case, in order to provide a smooth streaming service, the streaming server may store the bitstream for a certain period of time.

Examples of the user devices may include mobile phones, smartphones, laptop computers, digital broadcasting terminals, personal digital assistants (PDAs), portable multimedia players (PMPs), navigation devices, slate PCs, tablet PCs, ultrabooks, wearable devices (e.g., smartwatches, smart glasses, HMDs), digital TVs, desktop computers, digital signage, etc.

Each server in the above content streaming system may be operated as a distributed server, in which case data received from each server may be distributed and processed.

The above embodiments may be performed in the same or corresponding manner in the encoding apparatus and the decoding apparatus. In addition, an image may be encoded/decoded using at least one or a combination of at least one of the above embodiments.

The order in which the above embodiments are applied may be different in the encoding apparatus and the decoding apparatus. Alternatively, the order in which the above embodiments are applied may be the same in the encoding apparatus and the decoding apparatus.

The above embodiments may be performed for each of the luma and chroma signals. Alternatively, the above embodiments for the luma and chroma signals may be performed identically.

In the above-described embodiments, the methods are described based on the flowcharts with a series of steps or units, but the present disclosure is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present disclosure.

The embodiments may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present disclosure, or well-known to a person of ordinary skill in the computer software technology field.

A bitstream generated by the encoding method according to the above embodiment may be stored in a non-transitory computer-readable recording medium. In addition, a bitstream stored in the non-transitory computer-readable recording medium may be decoded by the decoding method according to the above embodiment.

Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high-level language code that may be implemented by a computer using an interpreter. The hardware devices may be configured to be operated by one or more software modules or vice versa to conduct the processes according to the present disclosure.

Although the present disclosure has been described in terms of specific items such as detailed elements as well as the limited embodiments and the drawings, they are only provided to help more general understanding of the invention, and the present disclosure is not limited to the above embodiments. It will be appreciated by those skilled in the art to which the present disclosure pertains that various modifications and changes may be made from the above description.

Therefore, the spirit of the present disclosure shall not be limited to the above-described embodiments, and the entire scope of the appended claims and their equivalents will fall within the scope and spirit of the invention.

### INDUSTRIAL APPLICABILITY

The present disclosure may be used in an apparatus for encoding/decoding an image and a recording medium for storing a bitstream.

What is claimed is:

1. A method for decoding an image, the method comprising:
partitioning a current block into a first partition and a second partition along a split boundary;
determining whether an intra block copy mode is applied to the first partition;
when the intra block copy mode is applied to the first partition, determining a block vector of the first partition that represents a reference block within a block vector search range of the current block;
determining a reference block referenced by the first partition based on the block vector; and
predicting the first partition based on the reference block.

2. The method of claim 1,
wherein whether the intra block copy mode is applied to the first partition is determined based on a first partitioning area flag,
wherein when the intra block copy mode is not applied to the first partition, the intra block copy mode is applied to the second partition, and
wherein when the intra block copy mode is applied to the first partition, whether the intra block copy mode is applied to the second partition is determined based on a second partitioning area flag.

3. The method of claim 1,
wherein whether the intra block copy mode is applied to the first partition is determined based on a first partitioning area flag, and whether the intra block copy mode is applied to the second partition is determined based on a second partitioning area flag.

4. The method of claim 1,
wherein the second partition applies one of an inter prediction mode, an intra prediction mode, an intra block copy mode, and an intra template matching mode.

5. The method of claim 4,
wherein irrespective of whether the intra block copy mode is applied to the first partition, a prediction method applied to the second partition is determined.

6. The method of claim 4,
wherein when the intra block copy mode is applied to the first partition and the intra prediction mode is applied to the second partition, the second partition is predicted by one of predetermined intra prediction methods,
wherein when the intra block copy mode is not applied to the first partition and the intra prediction mode is applied to the second partition, the second partition is predicted by one of prediction methods not included in the predetermined intra prediction methods, and
wherein the predetermined intra prediction methods include at least one of planar mode, DC mode, horizontal mode, or vertical mode.

7. The method of claim 4,
wherein when the intra block copy mode is applied to the first partition and the intra prediction mode is applied to the second partition, the second partition is predicted by one of regular intra prediction methods.

8. The method of claim 4,
wherein when the intra block copy mode is applied to both the first partition and the second partition, the block vector of the first partition and a block vector of the second partition are configured not to be identical to each other.

9. The method of claim 1,
wherein when the intra block copy mode is applied to the first partition and an inter prediction mode is applied to the second partition, the block vector of the first partition is derived based on a motion vector of the second partition.

10. The method of claim 9, further comprising:
acquiring a differential vector representing difference between the block vector of the first partition and the motion vector of the second partition,
wherein the block vector of the first partition is derived based on the motion vector of the second partition and the differential vector.

11. A method for encoding an image, the method comprising:
partitioning a current block into a first partition and a second partition along a split boundary;
determining whether an intra block copy mode is applied to the first partition;
when the intra block copy mode is applied to the first partition, determining a block vector of the first partition that represents a reference block within a block vector search range of the current block;
determining a reference block referenced by the first partition based on the block vector; and
predicting the first partition based on the reference block.

12. (canceled)

13. A method for transmitting a bitstream, which is generated by a method for encoding an image, the method comprising:
encoding an image based on the method for encoding an image; and
transmitting a bitstream including the encoded image,
wherein the method for encoding an image comprises:
partitioning a current block into a first partition and a second partition along a split boundary;
determining whether an intra block copy mode is applied to the first partition;
when the intra block copy mode is applied to the first partition, determining a block vector of the first partition that represents a reference block within a block vector search range of the current block;
determining a reference block referenced by the first partition based on the block vector; and
predicting the first partition based on the reference block.
